(19) United States
(12) Patent Application Publication
(10) Pub. No.: US 2020/0153702 A1
(43) Pub. Date: May 14, 2020

(54) METHODS AND NETWORK NODES ENABLING A CONTENT DELIVERY NETWORK TO HANDLE UNEXPECTED SURGES OF TRAFFIC

(71) Applicants: Adel LARABI, Pierrefonds (CA); Jennie Thu Diem VO, Montreal (CA)

(72) Inventors: Adel LARABI, Pierrefonds (CA); Jennie Thu Diem VO, Montreal (CA)

(73) Assignee: TELEFONAKTIEBOLAGET LM ERICSSON (PUBL), Stockholm (SE)

(21) Appl. No.: 16/618,260

(22) PCT Filed: Jun. 20, 2017
(86) PCT No.: PCT/IB2017/053671

§ 371 Date: Nov. 29, 2019

(51) Int. Cl. H04L 12/24; H04L 29/08; H04L 29/06; H04L 12/26

(52) U.S. Cl. CPC H04L 41/147; H04L 67/2842; H04L 65/80; H04L 67/327; H04L 67/02; H04L 67/322; H04L 67/2814; H04L 43/0817; H04L 67/36; H04L 67/101; H04L 43/0864; H04L 65/4084

(57) ABSTRACT

The disclosure relates to content delivery network and to methods and network nodes enabling the content delivery network to handle unexpected surges of traffic by computing and using a traffic prediction for a content for at least one delivery node.

### TECHNICAL FIELD

The present disclosure relates to content delivery networks and to methods and network nodes enabling the content delivery network to handle unexpected surges of traffic.

### BACKGROUND

Content delivery network or content distribution network (CDN) 10, such as the network illustrated in FIG. 1, have been developed and used to meet the growing commercial need for efficient delivery of different contents to end-users. It needs to be evolved further due to the growing of television (TV)/Video consumption over the internet (e.g. over the top (OTT) contents . . . ).

As a value-added network, CDN 10 is built on top of the internet to improve the round-trip time (RTT) which implies the quality of experience (QoE) when delivering any types of contents to end-users. This delivery is mainly orchestrated by 3 types of entities or functions:
Delivery nodes (DN) 70, which are replicas or surrogate servers deployed in different locations close to end-users 40 to provide a high availability (HA) and high performance network;
Control plane 50, to configure, monitor and operate the network of delivery nodes;
Request router (RR) 20 as key function that constantly calculates the cost of delivery (based on different factors from the control plane) from different delivery nodes to end-users from different perspectives (proximity, load, health, content affinity, etc.).

Two main different Request Routing mechanisms are used in CDN, one is hypertext transfer protocol (HTTP) and the other is domain name server (DNS) based. Below are some feature parities between these routing mechanisms:

TABLE 1

| | HTTP-RR | DNS-RR |
|---|---|---|
| Weighted round-robin | √ | √ |
| Health metrics | √ | √ |
| Load metrics | √ | √ |
| Proximity metrics | √ | Partially |
| Access policy/ | √ | Partially |
| Geo-location | | |
| Content awareness | √ | ∅ |

HTTP-RR is explicit compared to DNS-RR, which is more transparent. Video delivery (live, VOD, etc.) employs HTTP-RR mechanism more often as it is not only richer in term of features but also provides more control and efficiency in content delivery.

Referring to FIG. 2, with HTTP-RR mechanism, the RR 20 has two methods of determining the best DN 70 for serving an end-user request:
Selecting a healthy DN, in a round-robin fashion, from a cluster located at the region where the end-user originates the request.
Selecting a DN with stickiness, i.e. preferably selecting a same DN as previously selected, based on content affinity, which is known as Content Based Request Routing (CBRR).

The latter is a better fit for video on demand (VOD) delivery as it uses the storage efficiently when caching contents. Furthermore, it can also scale smoothly due to nature of the VOD traffic (i.e. low concurrency).

Live video traffic is also suitable for CBRR when there is a smooth increase in audience size, which translates into low initial concurrent delivery and traffic.

Turning to FIG. 3, if there is a set of users 51 streaming a live channel C1 on delivery node DN1, a new set S2 from the same region will also be routed to DN1 as the result of applying the CBRR algorithm. Since there already exists a session on DN1, any new requests would join the current session. This eliminates additional overhead on the next hop DN and/or Origin server 80 (FIG. 2). This kind of efficiency is ensured by the RRs, until the monitoring detects an increase in resource utilization that reaches an upper threshold, and triggers overload protection. This leads the RRs into scaling up delivery nodes, where a second DN would be selected to assist DN1 in delivering C1. This scaling up principle applies until there is no more resources in the network. Only when the traffic starts decreasing and reaching a lower threshold that a scale-down starts kicking in.

For a live flash-mob event such as sporting events, e.g. football games, music shows, or some breaking news, the feedback from the monitoring are often too late for scaling up. At instance t1, decisions have already been taken by RRs to route end-users to DN1 which was currently having a low processing load. However, sending such a high number of users at the same time to DN1 can create an instant overload on the node at t2. After being notified by monitoring service of the overload, RRs will of course scale up, and the overloading effect will cascade to the next selected delivery node. However, the experience of end-users who have been assigned to the overloaded DN1, at this point, have already suffered: either by streaming the lowest profile (dropped bit rate) or enduring big latency which would eventually chock up (dropped image quality and possible apparition of visual artifacts) the media players.

The situation described above makes it difficult to use CBRR for live channels during big events, thus making round-robin selection appear to be a more suitable choice. However, round-robin would mean distributing the delivery of the same channel across all DNs of the regional cluster during flash-mob events, hence causing more traffic and sessions on the next hop and origin servers.

### SUMMARY

There is provided a method, executed in a network node, for providing a traffic prediction for a content for a delivery node in a content delivery network. The method comprises getting an initial state of the delivery node and setting a current state to the initial state, computing the traffic prediction for the content for the delivery node based on the current state and providing the traffic prediction for the content for the delivery node to a second network node.

There is also provided a method, executed in a network node, for handling a request for a content in a content delivery network. The method comprises receiving the request for the content from a client, obtaining a traffic prediction for the content, for at least one of a plurality of delivery node, responsive to obtaining the traffic prediction for the content, selecting a delivery node of the plurality of delivery nodes for serving the content to the client and sending metadata associated to the request to a second network node.

There is provided a traffic analyzer for providing a traffic prediction for a content for a delivery node in a content delivery network comprising processing circuitry and a memory. The memory contains instructions executable by the processing circuitry whereby the traffic analyzer is operative to get an initial state of the delivery node and setting a current state to the initial state, compute the traffic prediction for the content for the delivery node based on the current state and provide the traffic prediction for the content for the delivery node to a second network node.

There is provided a request router for handling a request for a content in a content delivery network comprising processing circuitry and a memory. The memory contains instructions executable by the processing circuitry whereby the request router is operative to receive the request for a content from a client, obtain a traffic prediction for the content, for at least one of a plurality of delivery node, responsive to obtaining the traffic prediction for the content, select a delivery node of the plurality of delivery nodes for serving the content to the client and send metadata associated to the request to a second network node.

There is provided a content delivery network for providing contents to clients and able to handle unexpected surges of traffic. The content delivery network comprises at least one traffic analyzer as described previously and at least one request router as described previously. The at least one request router continuously receives traffic predictions from the at least one traffic analyzer.

### BRIEF DESCRIPTION OF THE DRAWINGS

FIG. 1 a schematic illustration of CDN high level architecture.

FIG. 2 is a schematic illustration showing a request router in a CDN.

FIG. 3 is a schematic illustration of an example problem.

FIG. 4 is a diagram showing transactions per seconds (TPS) spikes caused by a Flash Mob according to an embodiment.

FIG. 5 is a schematic illustration of an example embodiment including a traffic analyzer.

FIG. 6 is schematic illustration of an embodiment that solves the exemplary problem illustrated in FIG. 3.

FIG. 7 is flow diagram of an example embodiment.

FIG. 8 is a schematic illustration of an alternate example embodiment.

FIG. 9 is a flowchart of a method executed by a traffic analyzer according to an embodiment.

FIG. 10 is a flowchart of a method executed by a request router according to an embodiment.

FIG. 11 is a schematic illustration of a network node according to an embodiment.

FIG. 12 is a schematic illustration of a cloud environment in which some embodiments of the traffic analyzer and of the request router can be deployed.

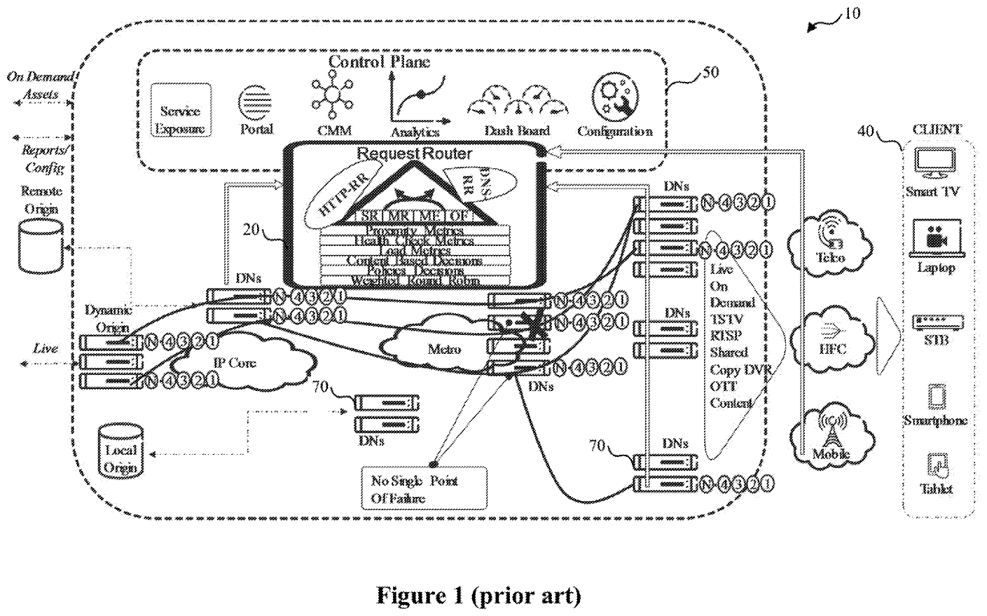

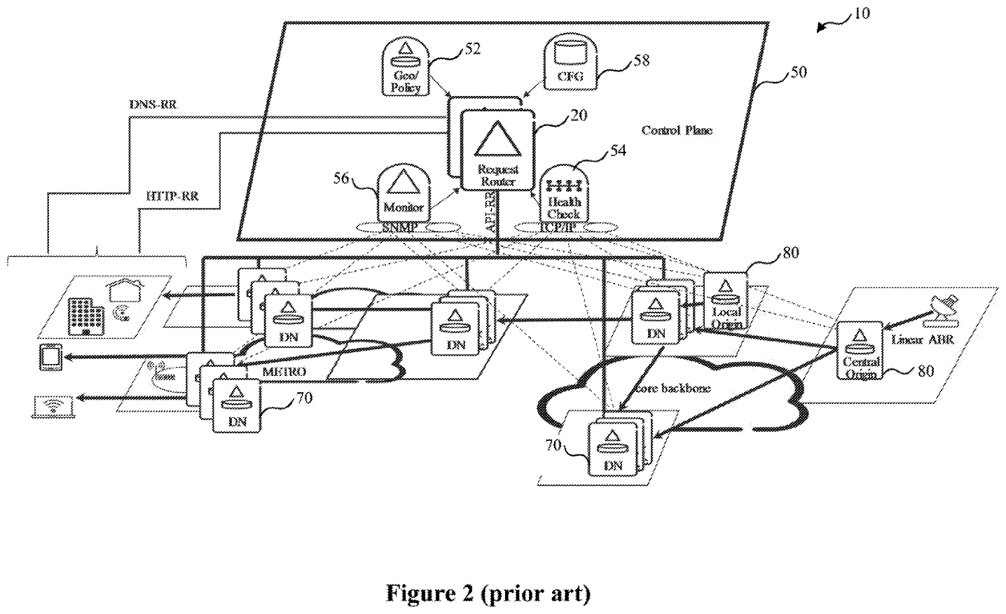

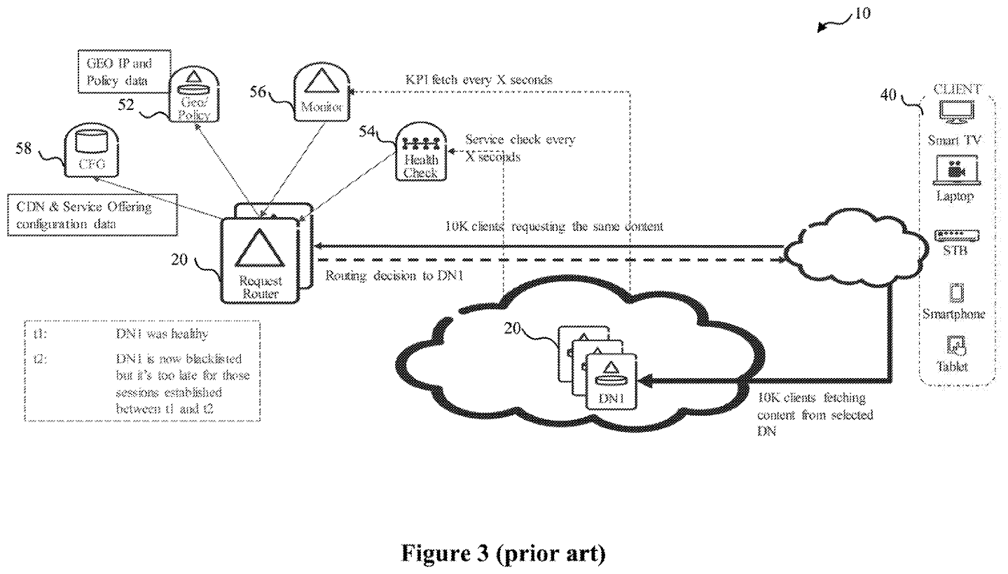

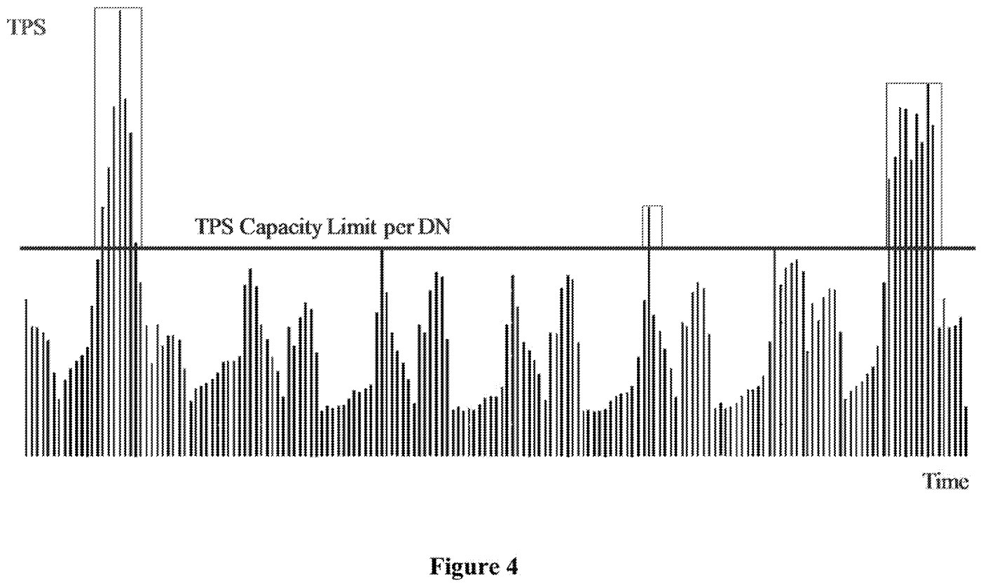

### DETAILED DESCRIPTION

Various features and embodiments will now be described with reference to the figures to fully convey the scope of the disclosure to those skilled in the art.

Many aspects will be described in terms of sequences of actions or functions. It should be recognized that in some embodiments, some functions or actions could be performed by specialized circuits, by program instructions being executed by one or more processors, or by a combination of both.

Further, some embodiments can be partially or completely embodied in the form of computer readable carrier or carrier wave containing an appropriate set of computer instructions that would cause a processor to carry out the techniques described herein.

In some alternate embodiments, the functions/actions may occur out of the order noted in the sequence of actions or simultaneously. Furthermore, in some illustrations, some blocks, functions or actions may be optional and may or may not be executed; these are generally illustrated with dashed lines.

The solution to the above-mentioned problem illustrated in FIG. 4, in a nutshell, is to quickly and smartly detect flash-mob events and act on it, thus ultimately avoiding overloading the delivery network and impacting user QoE. In this solution, CBRR is used in a dynamical way to positively impact video delivery.

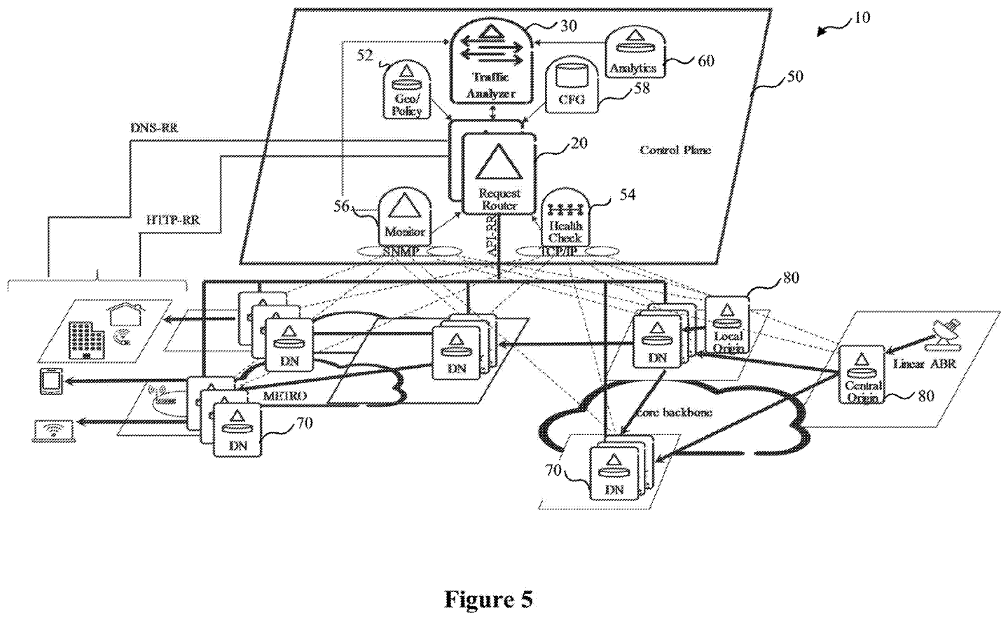

Turning to FIG. 5, it is proposed to add atop the existing traffic KPIs collected from the DNs 70 a traffic prediction service, utilizing a traffic analyzer 30 and an analytics component 60, which records not only the density of user requests newly arriving at RRs 20 but also their related service offering meta data. This, in turn, provides the RR 20 with the capability to calculate and predict the traffic load in DNs before a redirection decision is made.

The real-time nature of the prediction service should compensate for the gap time between KPI collection intervals. A flash mob scenario should be detected the moment it starts, allowing the RR to respond in the most proactive way in order to optimize CBRR for efficient utilization of CDN resources.

The introduction of the traffic load predictive capability in RR should help the RR smoothly handle flash mob events without penalizing the end user streaming experience.

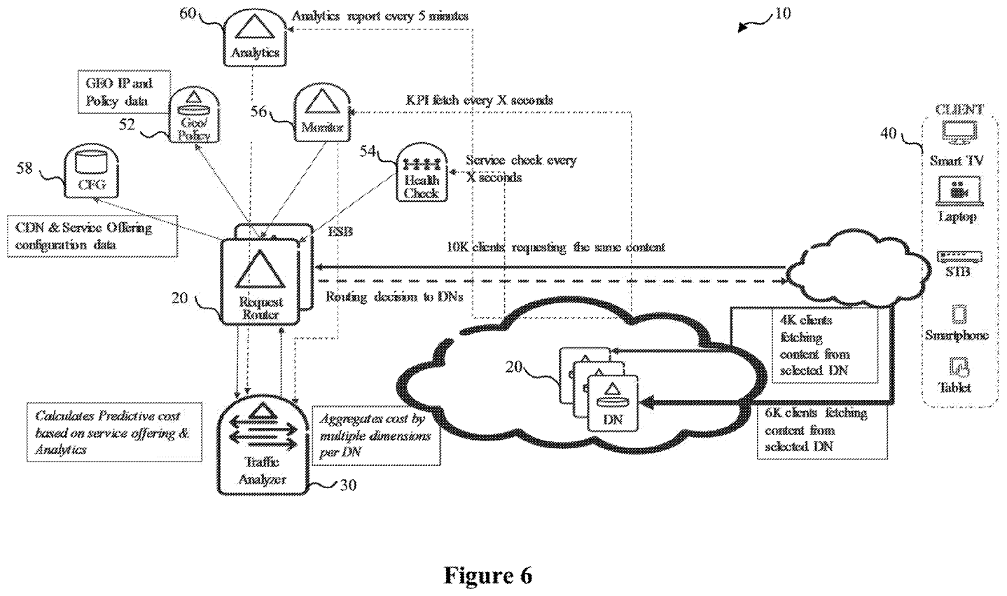

FIG. 6 depicts an example flash mob event that comes with 10K simultaneous requests for the same channel or content. Based on the cost calculated from different dimensions (e.g. throughout, CPU, latency . . . ) on each DN, in addition to the newly acquired predicted cost based on the service level defined on service offerings of these new requests, the RR is better equipped to use CBRR more intelligently and split these 10K sessions among two DNs.

The proposed solution, that will be described in more details further below, should benefit not only the utilization of CDN but also the end user experience in preventing DNs from sudden surges in traffic leading to resource overload and in protecting end users from suffering poor service quality. Further, DNS-RR based traffic, like web content, should also benefit from the cost prediction added to the weighted round robin feature. The solution should also allow eliminate the need for roll back from CBRR to basic Round Robin method, which increases the load on the origin servers.

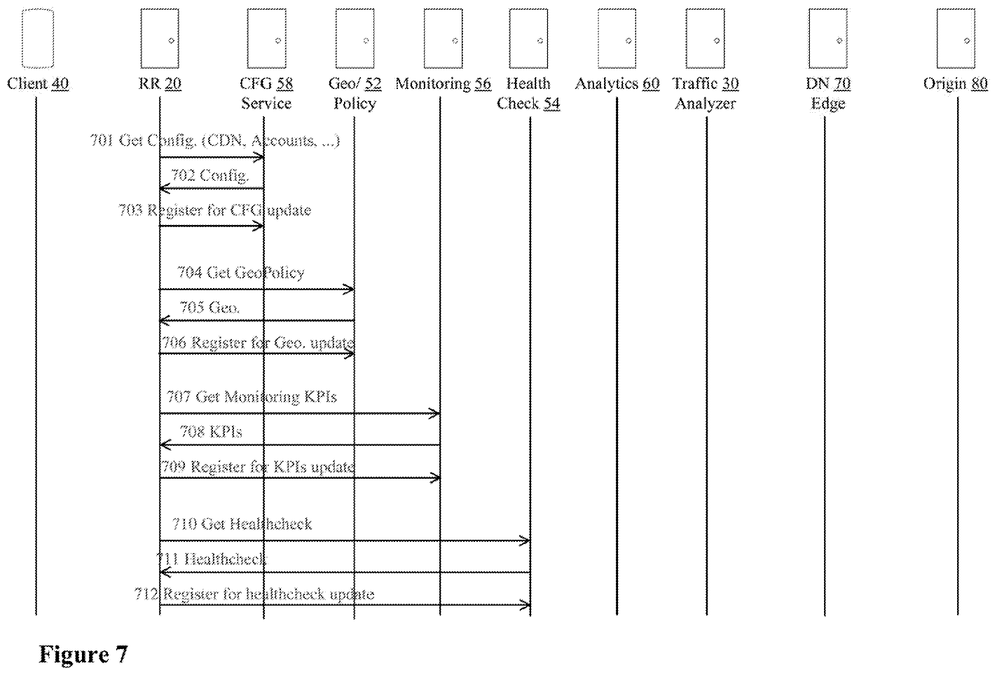

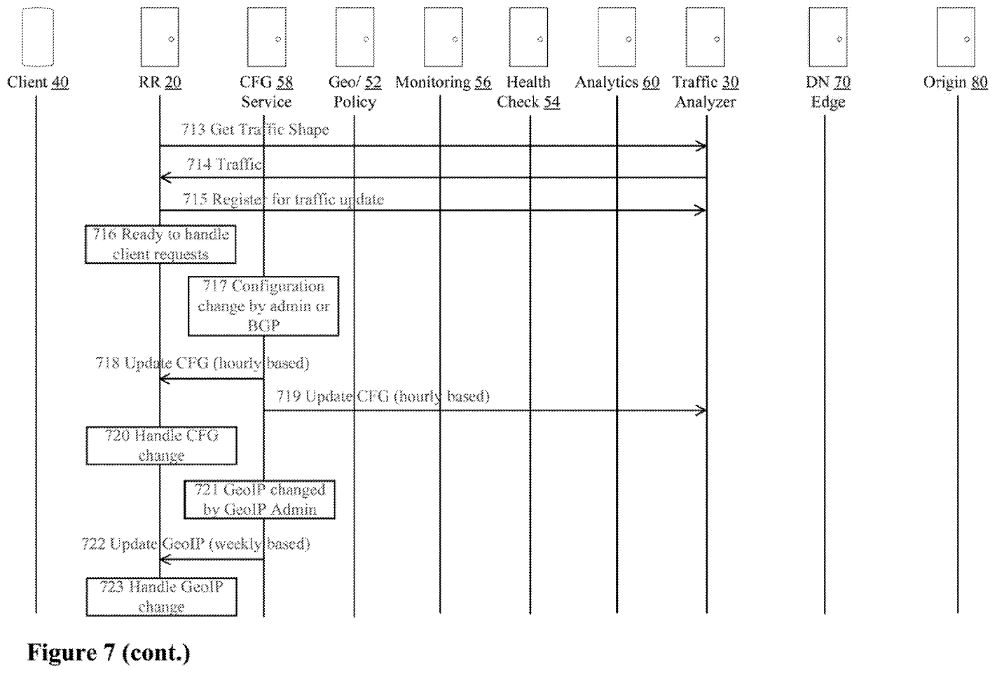

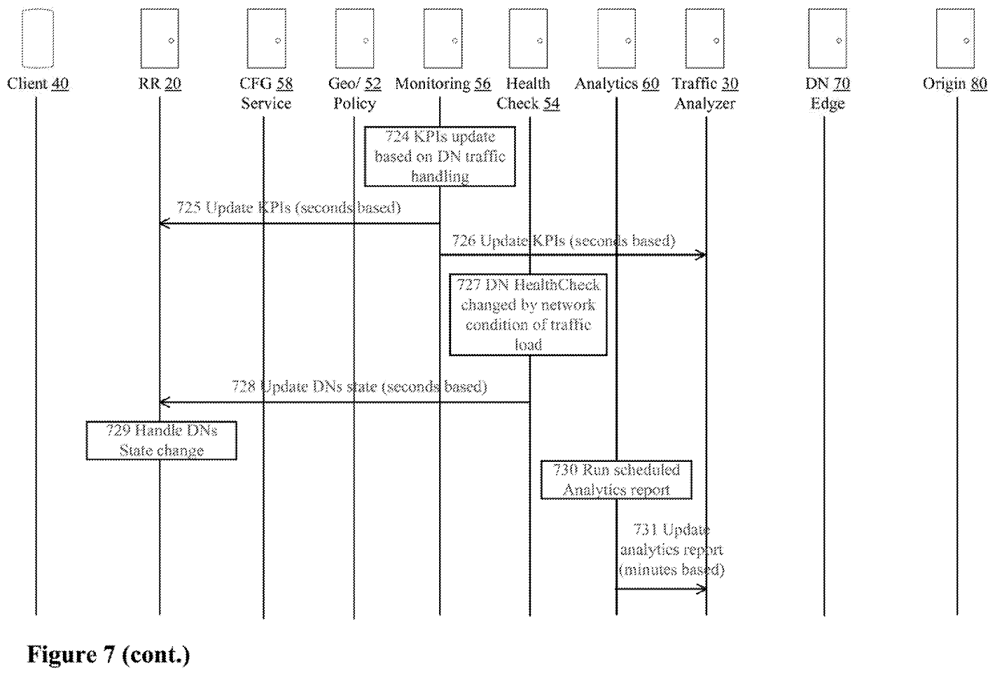

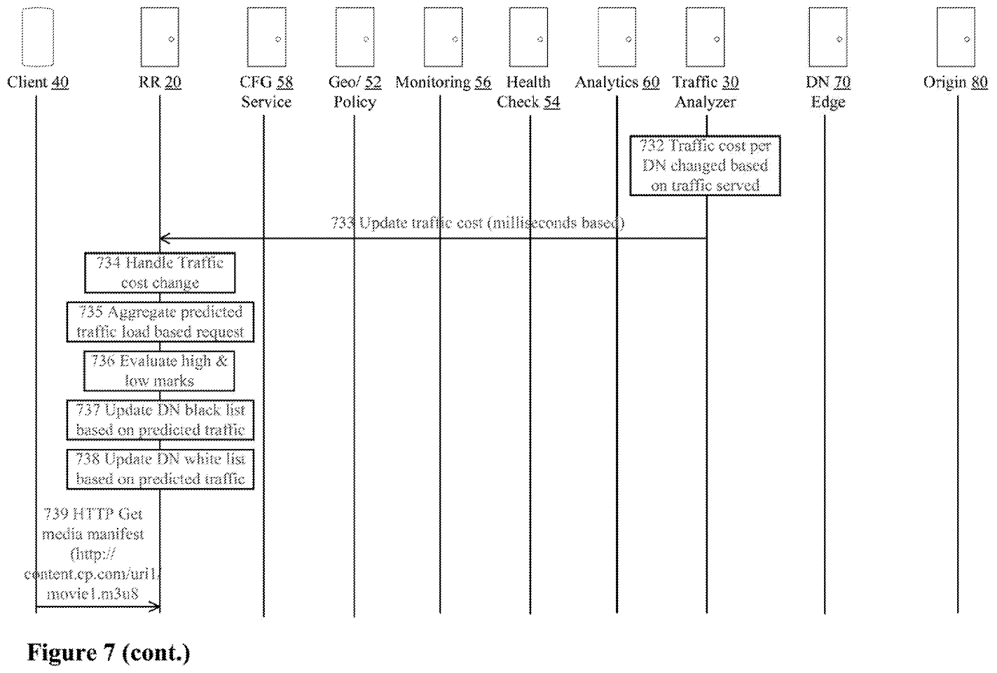

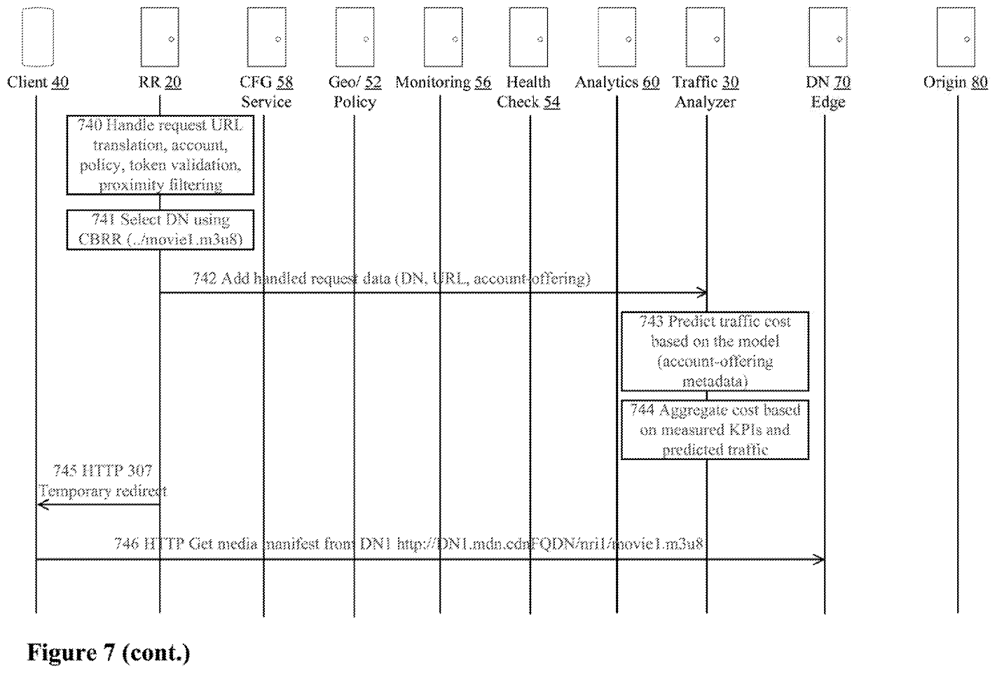

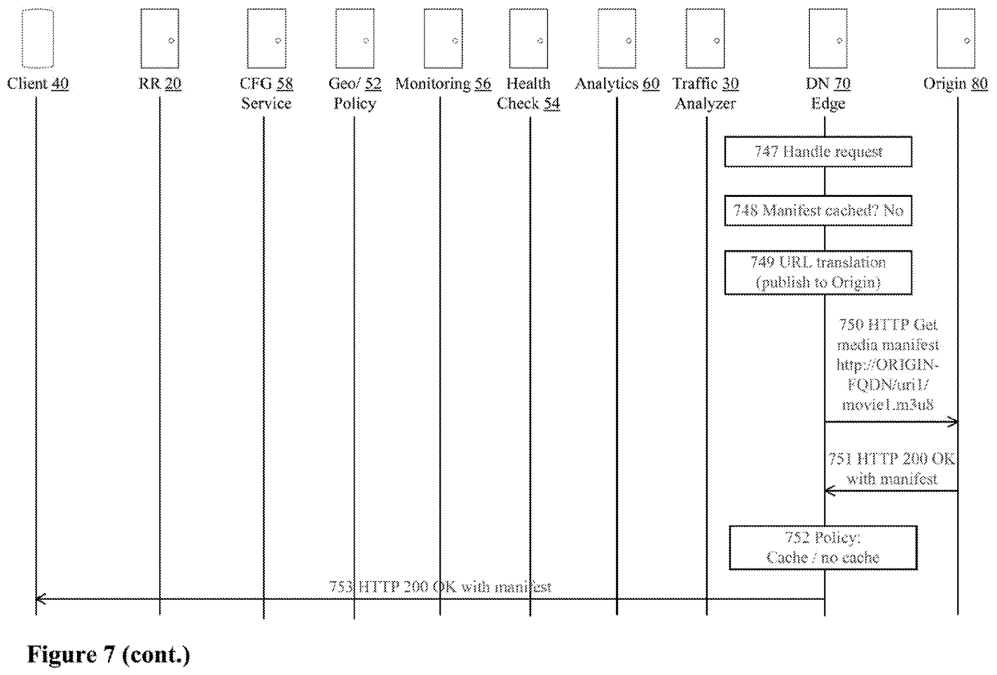

The RR with predictive routing service will now be described in more details with reference to the example illustrated in FIG. 7, which is an example of an overall operating sequence in the control plane with the interaction between different components in order to support Flash Mob, or unexpected traffic surge, events.

As previously described, RRs 20 today operates in stateless mode. The RR decision-making ability is based-on data gathered from past/ongoing traffic on DNs 70. The solution proposed herein brings the RR 20 from a reactive to a proactive mode by introducing two levels of intelligence: the assistance of machine learning which operates on big data previously gathered; and the tracking of new traffic being redirected to each DN 70. With this, the RR possesses the capability to calculate ongoing traffic, and to predict new traffic load prior to making the decision as to which DN to redirect incoming requests from clients 40.

At initial steps 701 to 715, the request router 20 gets information from different nodes, namely configuration (CFG) 58, geo/policy 52, monitoring KPIs 56, health check 54 and traffic analyzer 30 and register for updates from these network nodes. The configuration data requested and received from the CFG service node 58, steps 701-702, can include CDN topology (network, DNs, IP meshes . . . ) and service offering (live/video-on-demand, HDS/HLS . . . ) configuration, for example. The geo/policy data requested and received from the Geo/Policy node 52, steps 704-705, concerns the client access policies relating to Internet Protocol (IP) geo-locations. The monitoring KPI data requested and received from the Monitoring node 56, steps 707-708, can comprise data such as, central processing unit (CPU), throughput and latency data per DN, for example. The health check data requested and received form the Health check node 54, steps 710-711, relates to the continuous monitoring of the service availability of the DNs (e.g. network connectivity, port reachability, etc.). The traffic data requested and received from the traffic analyzer node 30, steps 713-714, is the traffic shape of an initial snapshot of the predicted traffic when the traffic analyzer starts up. The RR is then ready to handle client requests, step 716.

At steps 717, the configuration is changed in the CFG service 58. The RR is updated at step 718 and the traffic analyzer 30 is updated at step 719. The updated information sent from the CFG node to the RR and to the traffic analyzer 30 can comprise information such as described in relation to table 2 further below. The RR handles the CFG change i.e. updates the configuration information that the RR locally stores at step 720. This kind of updates happen approximately on an hourly basis.

At step 721 the GeoIP is changed. For example, new IP ranges can be added. The RR is updated, step 722, and handles the GeoIP change, e.g. by storing the new IP ranges in a local copy of its memory, step 723. This kind of update happens approximately on a weekly basis.

At step 724, there is a KPI update which is based on the DN traffic handling. The updated information is sent from the monitoring node 56 to the RR 20 at step 725 and to the traffic analyzer 30 at step 726 and can comprise information such as described in relation to table 2 further below. This kind of updates happen approximately on a seconds basis, and can be every several seconds, for example every ten seconds.

At step 727, the DN health check is changed by network conditions of traffic load. The Health check node 54 updates the RR 20 with updated DNs state at step 728. This kind of updates happen approximately on a seconds basis. At step 729, the RR handles the DNs state change. For example, the RR updates the blacklist and whitelist of DNs. Using the blacklist and whitelist, the RR can redirect incoming user requests only to healthy DNs.

The analytics node 60 runs scheduled analytics report, step 730, and updates the traffic analyzer accordingly approximately every minute, step 731. Running the analytics report can comprise measuring the number of requests and transactions per second, by DN, as well as measuring packet size and cache duration (i.e. max-age header value per account offering. The analytics report can be based on information such as described in relation to table 2 further below.

In response to receiving the analytics report, the traffic analyzer (TA) 30 computes a traffic cost per DN based on the traffic served, step 732, and updates the RR 20 with the traffic cost. This kind of updates happen approximately on a milliseconds basis. The RR 20 then handles the traffic cost change, steps 734 to 735. The RR aggregates the predicted traffic load per DN based on the requests, each request having a weight determined based on different dimensions such as CPU, bandwidth and latency requirements, step 735. The RR then evaluates high and low marks, step 736t, i.e. the upper and lower KPI thresholds (bandwidth, CPU . . . ) being used by RR to blacklist and whitelist a DN, i.e. blacklist when exceeding the high mark and whitelist only when it goes below the low mark. This would prevent the jittering effect on the DN. The RR updates the DN blacklist and whitelist that it keeps based on predicted traffic, steps 737 and 738.

At this point, the RR 20 is ready to receive new client requests, step 739. In the example of FIG. 7, the client request is for a media manifest, which comprises information regarding the content such as mp4 segments, quality level, etc. The RR handles the request by doing URL translation, account, policy, token validation, proximity filtering, step 740. This step is basically a normalization that the RR does for the CDN to process the request by translating the URL to have it unique in the CDN and grant the access by checking a token and applying a policy based on account configuration. The RR is then ready to select a DN for serving the request, step 741. The selection of the DN may be done using CBRR, but other algorithms could also be used as would be apparent to a person skilled in the art.

At step 742, the RR sends the request data (selected DN, URL, account-offering information) to the traffic analyzer. Account offering may be defined as a service canvas holding the specific feature configurations related to the service level agreement, as an example, a content provider (e.g. Radio-Canada) account for HLS delivery to particular devices, (e.g. iPhone® devices). In response, the traffic analyzer predicts traffic cost based on the model (account-offering metadata) which comprise characteristics of the content of the content provider, step 743 and aggregates cost (such as CPU, bandwidth and latency costs), per DN, based on measured KPI and predicted traffic, step 744.

The RR sends a temporary redirect to the client at step 745, and the client requests to get the media manifest from node DN1 at step 746.

The DN handles the request at steps 747 to 752, where it checks if the manifest is cached locally at step 748, the DN does URL translation (from an external path to an internal path to the CDN) at step 749, the RR sends an HTTP request for the media manifest to the origin server 80 at step 750 and received a response with the manifest at step 752. At step 753, the DN sends the manifest to the client. The client can then start playing the requested content.

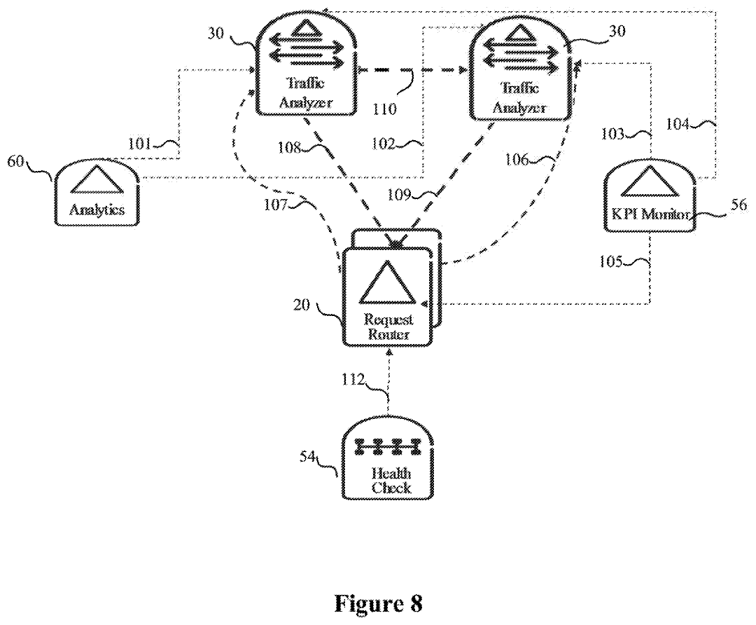

FIG. 8 illustrates how the traffic analyzer function can operate in tandem, i.e. with a plurality of traffic analyzer nodes working together. Dashed lines 101-110 illustrate data flow between the nodes and correspond to data flows explained previously. For example, the Analytics node 60 feeds 101, 102 the traffic analyzers with analytics reports. A traffic analyzer 30 can provide data 110 to a second (may be redundant) traffic analyzer 30. Request routers send request data 106, 107 to the traffic analyzer and the traffic analyzers provide traffic predictions 108, 109 to the RRs 20. Health check node 54 provides data 112 to the RRs 20 and KPI monitor node 56 provides KPI data 103, 104, 105 to the TA 30 and RRs 20.

To ensure a fast processing speed in the RR 20, the data predicted by TA 30 should be persistent in memory and should be available for instantaneous retrieval. Therefore, in one embodiment, it is proposed to have two TAs 30 operating in tandem. Both TA can register to received update from KPI monitor 56 and Redirected Request Data (see step 742 of FIG. 7) from all RRs. Should one TA go down, the other would keep the information flowing and provide up-to-date data to all active RRs and to the failed TA when it comes back up.

The traffic analyzer interoperation is now explained. The TA can base its traffic prediction on inputs from different components:
CFG: which provides somewhat static metadata of the account-offering (AO);
KPI Monitor: which provides KPI measures collected from all operating DNs;
Analytics: Machine learning and predictive data on user traffic built per AO and DN; and
RRs: newly redirected client requests.

Throughout the operation, RRs and TAs will continuously exchange with each other feedback data:
At every HTTP redirection, RR updates TA with the client dynamic data: which DN this request is redirected to, what is the service offered to this client, what is the video the client is about to stream, etc.;
By aggregating the user data constantly pushed from all RRs and normalize them on top of periodically updated KPI and Analytics, TA will be able to have a bird eye view of the entire data plane. This valuable information is then fed back to all RRs for real-time traffic redirection.

Traffic Update Frequency at the TA update may be calculated as follows:

f_{TA}=1000/(R_{RR}/R_{DN})
where:
R_{RR}: TPS of each RR
R_{DN}: TPS of each DN
f_{TA}: Frequency of TA publish (msec)

For the remaining of the document, f_{TA} will be assumed to have a value of 50 msec but of course this value could be different.

The prediction function in TA is based on a formula with a combination of static, dynamic, measured and predicted inputs from four different components at different time intervals as explained previously:

TABLE 2

| Component | Characteristics | Parameters |
|---|---|---|
| CFG | Static | Mapping of each Account-offering (AO) to its |
| | | static metadata: |
| | | Content type: live, video on demand (VoD) |
| | | Service type: HTTP Dynamic Streaming |
| | | (HDS), HTTP Live Streaming (HLS), |
| | | Dynamic Adaptive Streaming over HTTP |
| | | (DASH) . . . |
| | | Whether the streaming content is to be |
| | | memory-cached |
| RR | Dynamic | Newly redirected request: |
| | | AO |
| | | Uniform resource locator (URL) content |
| | | Redirected DN |
| KPI | Measured | KPI measured per DN: |
| Monitor | | Central processing unit (CPU) |
| | | Throughput |
| | | Latency |
| Analytics | Predictive | Measures per DN: |
| | | Number of requests |
| | | TPS |
| | | Measures per AO |
| | | Packet size |
| | | Cache duration (Max-Age header value) |

Using inputs such as those enumerated in table 2, the TA can predict the traffic load in the DNs with the following formula:

F_{TA}=F_{ao(S,D,P)}+F_{dn(M,P)}
Where:
F_{TA}: Traffic Analyzer Function
Fₐₒ: Account offering function
F_{dn}: Delivery node function
S: Static KPI
D: Dynamic KPI
M: Measured KPI
P: Predicted KPI

In an example embodiment, the different KPIs could be defined and/or have values such as:

S, Static KPI: AccountOfferingID=123, ContentType=HSS, ServiceType=Live, CachingType=Memory.

D, Dynamic KPI: AccountOfferingID=123, URLparth=/channel1/qualitylevel . . . , SelectedDN=DN1.

P, Predicted KPI: AccountOfferingID=123, SelectedDN=DN1, AvgSize=1612345, TPS=600.

M, Measured KPI: SelectedDN=DN1, CPU=45, Throughput=4123456789, latency=123.

The account offering function could be defined as: ((a/AvgSize)+(b/ContentType)+(c/ServiceType)+(d/CachingType)), where: a+b+c+d=100%.

The delivery node function could be defined as: (CPU/TPS; Throughput/TPS) where CPU-cost=CPU/TPS and Throughput-cost=Throughput/TPS; cost referring to both CPU and Throughput cost.

Of course, in other embodiments, the functions could be defined differently, according to system design and needs, as would be apparent to a person skilled in the art.

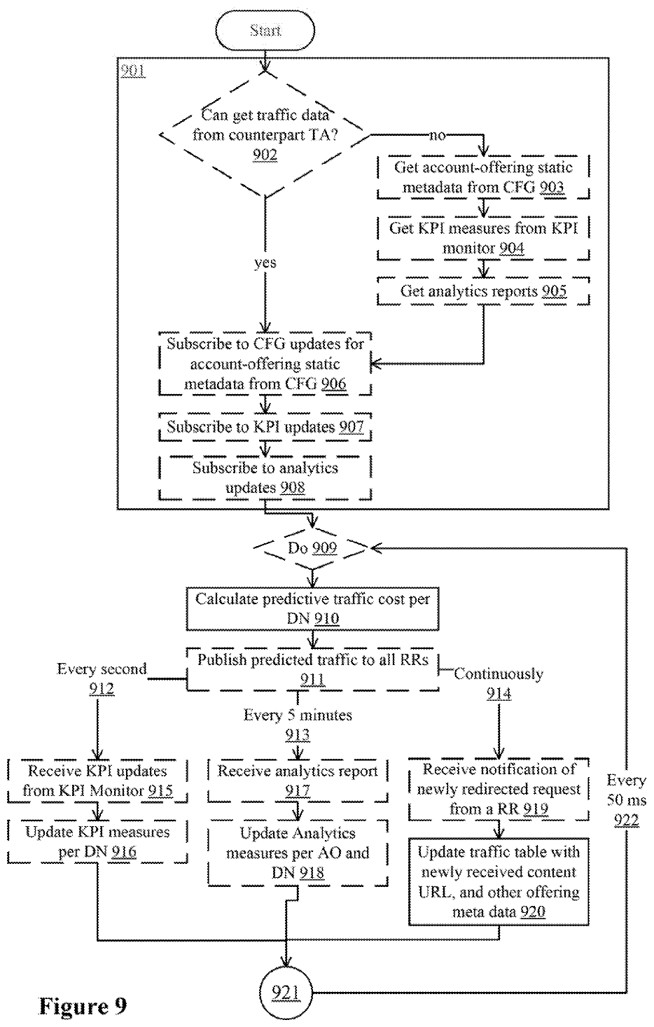

Turning to FIG. 9, a method, executed in a network node, for providing a traffic prediction for a content for a delivery node in a content delivery network is illustrated. The method comprises getting an initial state of the delivery node and setting a current state to the initial state, step 901; computing the traffic prediction for the content for the delivery node based on the current state, step 910; and providing the traffic prediction for the content for the delivery node to a second network node.

In the method, getting an initial state of the delivery node may comprise getting configuration, step 903, performance indicators, step 904, and an analytics report, step 905, from a counterpart traffic analyzer; and subscribing to configuration, performance indicators, and analytics report, updates, steps 906-908, from the counterpart traffic analyzer.

In the method, getting an initial state of the delivery node may comprise getting configuration, performance indicators and an analytics report from a configuration node, monitoring node and an analytics node respectively; and subscribing to configuration, performance indicators and analytics report updates, steps 906-908, from the configuration node, monitoring node and analytics node respectively.

Getting an initial state may comprise getting an initial state for a plurality of delivery nodes.

The traffic prediction may be a function of static, dynamic and predicted account offering and of measured and predicted traffic at the delivery node.

In the method, providing the traffic prediction for the content may comprise providing the traffic perdition for the plurality of delivery nodes and the traffic prediction may be provided to a request router, step 911.

The traffic prediction may be provided to a plurality of request routers.

The method may further comprise receiving configuration, performance indicators and analytics report updates, steps 915 and 917, and updating the current state, steps 916 and 918.

The current state may further comprise a traffic status and the method may further comprise receiving a redirected request update from the request router, step 919; and updating the traffic status with information related to the redirected request, step 920.

The performance indicators update may occur approximately every second or it could alternatively happen every ten seconds, step 912 and the analytics report update may occur approximately every five minutes, step 913. The redirected request update may occur continuously, step 914. The traffic status may be stored in a traffic table. Steps 910 to 920 are executed in loop, steps 909 and 921 and may be executed, for example, every 50 milliseconds, step 922.

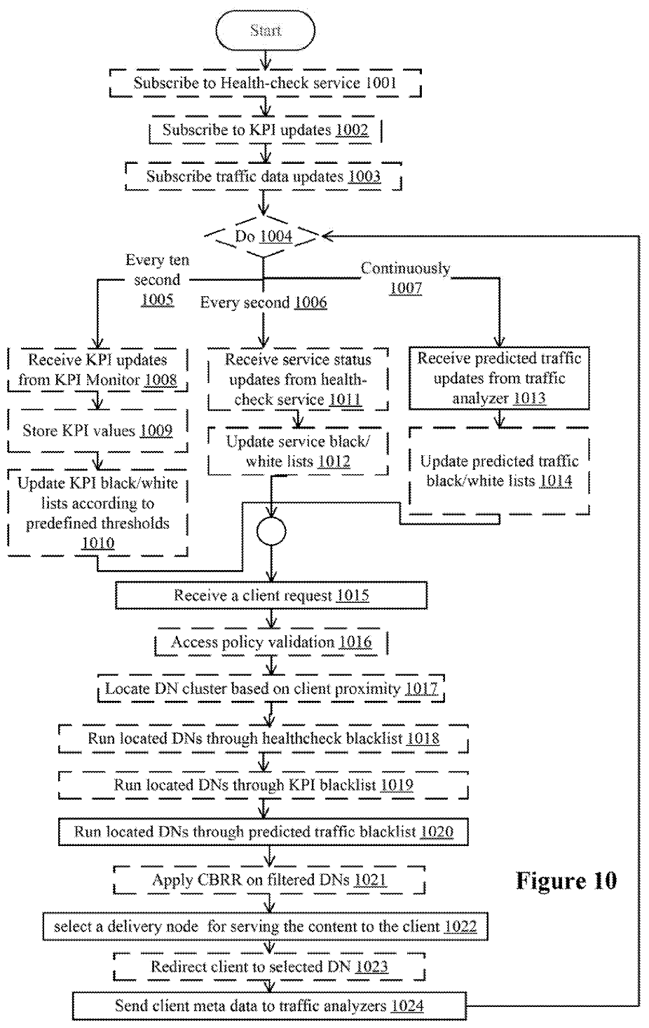

Turning to FIG. 10, a method, executed in a network node, for handling a request for a content in a content delivery network, is illustrated. The method comprises receiving a request for a content from a client, step 1015; obtaining a traffic prediction for the content, for at least one of a plurality of delivery node, step 1013; responsive to obtaining the traffic prediction for the content, selecting a delivery node of the plurality of delivery nodes for serving the content to the client, step 1022; and sending metadata associated to the request to a second network node, step 1024.

The method may further comprise subscribing to a health check service, subscribing to performance indicators updates and subscribing to traffic prediction updates, steps 1001, 1002 and 1003, for the plurality of delivery nodes.

The method may further comprise receiving and storing performance indicators, steps 1008 and 1009; and updating a black list of delivery nodes as a function of the performance indicators, step 1010.

The method may further comprise receiving services statuses from the health check service, step 1011; and updating a black list of delivery nodes as a function of the services statuses, step 1012.

The method may further comprise, after the step of receiving traffic predictions from a traffic analyzer, step 1013, updating a black list of delivery nodes as a function of the traffic predictions, step 1014.

The network node may be a request router and the second delivery node may be a traffic analyzer. The performance indicators may be received approximately every ten seconds, step 1005. The services statuses may be received approximately every second, step 1006. The traffic predictions may be received continuously, step 1007.

In the method, selecting a delivery node may further comprise access policy validation, step 1016, locating a delivery nodes cluster based on client proximity, step 1017; discarding delivery nodes from the cluster if said delivery nodes are listed in the blacklist of delivery nodes, steps 1019 to 1020; applying a content based request routing algorithm to select a delivery node, step 1021; and redirecting the request from the client to the selected delivery node, step 1023. Steps 1005 to 1024 are executed in loop, step 1004.

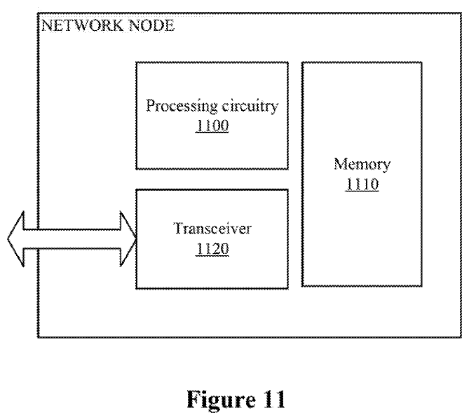

Referring to FIG. 11, which shows basic components of a network node, a traffic analyzer 30 for providing a traffic prediction for a content for a delivery node 70 in a content delivery network 10 is illustrated. The traffic analyzer 30 comprises processing circuitry 1100 and a memory 1110. The memory 1110 contains instructions executable by the processing circuits 1100 whereby the traffic analyzer 30 is operative to execute the method described previously, including getting an initial state of the delivery node and setting a current state to the initial state; computing the traffic prediction for the content for the delivery node based on the current state; and providing the traffic prediction for the content for the delivery node to a second network node.

Still referring to FIG. 11, which shows basic components of a network node, alternatively, a request router 20 for handling a request for a content in a content delivery network 10 is illustrated. The request router comprises processing circuitry 1100 and a memory 1110, the memory 1110 containing instructions executable by the processing circuitry 1100 whereby the request router 20 is operative to execute the method described previously, including receiving a request for a content from a client; obtaining a traffic prediction for the content, for at least one of a plurality of delivery node 70; responsive to obtaining the traffic prediction for the content, selecting a delivery node of the plurality of delivery nodes for serving the content to the client and sending metadata associated to the request to a second network node.

FIG. 11 illustrates components of a network node. In some embodiments, the traffic analyzer 30 or the request router 20 are in the form of a physical network node which comprise processing circuitry 1100, a memory 1110 and a transceiver 1120.

FIG. 11 is a block diagram of a network node suitable for implementing aspects of the embodiments disclosed herein, such as the TA 30 or the RR 20. The network node includes a communications interface 1120, which can also be called a transceiver. The communications interface 1120 generally includes analog and/or digital components for sending and receiving communications to and from mobile devices within a wireless coverage area of the network node, as well as sending and receiving communications to and from other network nodes, either directly or via the content delivery network. Those skilled in the art will appreciate that the block diagram of the network node necessarily omits numerous features that are not necessary for a complete understanding of this disclosure.

Although all of the details of the network node are not illustrated, the network node comprises one or several general-purpose or special-purpose processors, or processing circuitry 1100, or other microcontrollers programmed with suitable software programming instructions and/or firmware to carry out some or all of the functionality of the network node described herein. In addition, or alternatively, the network node may comprise various digital hardware blocks (e.g., one or more Application Specific Integrated Circuits (ASICs), one or more off-the-shelf digital or analog hardware components, or a combination thereof) (not illustrated) configured to carry out some or all of the functionality of the network node described herein. A memory 1110, such as a random access memory (RAM), may be used by the processing circuitry 1100 to store data and programming instructions which, when executed by the processing circuitry 1100, implement all or part of the functionality described herein. The network node may also include one or more storage media (not illustrated) for storing data necessary and/or suitable for implementing the functionality described herein, as well as for storing the programming instructions which, when executed on the processing circuitry 1100, implement all or part of the functionality described herein. One embodiment of the present disclosure may be implemented as a computer program product that is stored on a computer-readable storage medium, the computer program product including programming instructions that are configured to cause the processing circuitry 1100 to carry out the steps described herein.

Referring back to FIG. 5, there is provided a content delivery network for providing contents to clients and able to handle unexpected surges of traffic. The content delivery network comprises at least one traffic analyzer 30 as previously described and at least one request router 20 as previously described, wherein the at least one request router continuously receives traffic predictions from the at least one traffic analyzer.

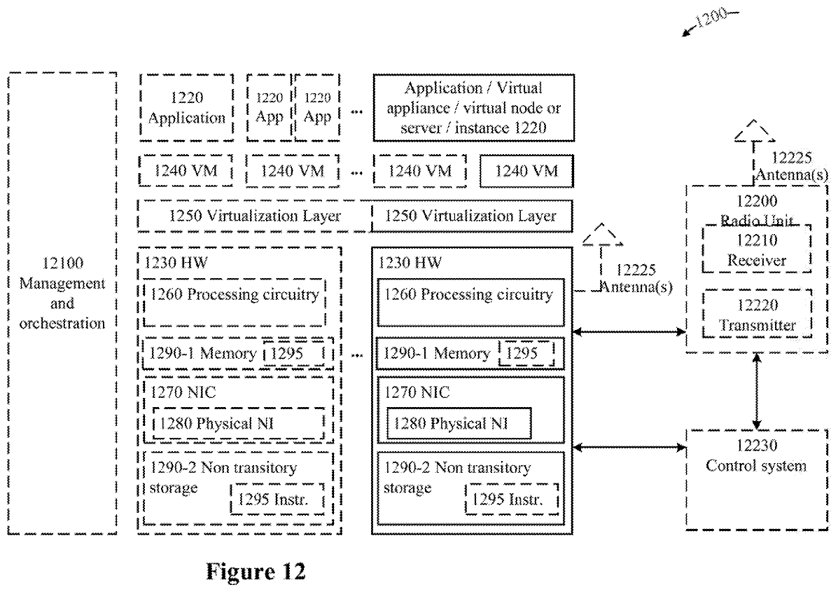

Turning to FIG. 12, there is provided a schematic block diagram illustrating a virtualization environment 1200 in which functions implemented by some embodiments may be virtualized. As used herein, virtualization can be applied to the traffic analyzer or to the request router and relates to an implementation in which at least a portion of the functionality is implemented as one or more virtual components (e.g., via one or more applications, components, functions, virtual machines executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in some embodiments the network node may be entirely virtualized.

The functions may be implemented by one or more applications 1220 (which may alternatively be called software instances, virtual appliances, network functions, virtual nodes, virtual network functions, etc.) operative to implement steps of some methods according to some embodiments. Applications 1220 run in virtualization environment 1200 which provides hardware 1230 comprising processing circuitry 1260 and memory 1290. Memory 1290 contains instructions 1295 executable by processing circuitry 1260 whereby application 1220 is operative to provide any of the relevant features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by the processing circuitry 1260. Each hardware devices may comprise one or more network interface controllers 1270 (NICs), also known as network interface cards, which include physical network interface 1280. Each hardware devices may also include non-transitory, persistent, machine readable storage media 1290-2 having stored therein software 1295 and/or instruction executable by processing circuitry 1260. Software 1295 may include any type of software including software for instantiating one or more virtualization layers 1250 (also referred to as hypervisors), software to execute virtual machines 1240 as well as software allowing to execute functions described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node, with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a virtual machine 1240 is a software implementation of a physical machine that runs programs as if they were executing on a physical, non-virtualized machine. Each of virtual machines 1240, and that part of the hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signaling can be effected with the use of control system 12230 which may alternatively be used for communication between the hardware nodes 1230 and the radio units 12200.

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method, executed in a network node, for providing a traffic prediction for a content for a delivery node in a content delivery network, comprising:
getting an initial state of the delivery node and setting a current state to the initial state;
computing the traffic prediction for the content for the delivery node based on the current state; and
providing the traffic prediction for the content for the delivery node to a second network node.

2. The method of claim 1, wherein getting the initial state of the delivery node comprises:
getting configuration, performance indicators and an analytics report from a counterpart traffic analyzer; and
subscribing to configuration, performance indicators and analytics report updates from the counterpart traffic analyzer.

3. The method of claim 1, wherein getting the initial state of the delivery node comprises:
getting configuration, performance indicators and an analytics report from a configuration node, monitoring node and an analytics node respectively; and
subscribing to configuration, performance indicators and analytics report updates from the configuration node, monitoring node and analytics node respectively.

4. The method of claim 1, wherein getting the initial state comprises getting the initial state for a plurality of delivery nodes.

5. The method of claim 1, wherein computing the traffic prediction is a function of static, dynamic and predicted account offering and of measured and predicted traffic at the delivery node.

6. The method of claim 4, wherein providing the traffic prediction for the content comprises providing the traffic prediction for the plurality of delivery nodes and wherein the traffic prediction is provided to a request router.

7. The method of claim 6, wherein the traffic prediction is provided to a plurality of request routers.

8. The method of claim 1, further comprising receiving configuration, performance indicators and analytics report updates and updating the current state.

9. The method of claim 6, wherein the current state further comprises a traffic status and wherein the method further comprises:
receiving a redirected request update from the request router; and
updating the traffic status with information related to the redirected request.

10. The method of claim 8 wherein the performance indicators update occurs approximately every second and the analytics report update occurs approximately every five minutes.

11. The method of claim 9, wherein the redirected request update occurs continuously.

12. The method of claim 9, wherein the traffic status is stored in a traffic table.

13. A method, executed in a network node, for handling a request for a content in a content delivery network, comprising:
receiving the request for the content from a client;
obtaining a traffic prediction for the content, for at least one of a plurality of delivery node;
responsive to obtaining the traffic prediction for the content, selecting a delivery node of the plurality of delivery nodes for serving the content to the client; and
sending metadata associated to the request to a second network node.

14. The method of claim 13, further comprising subscribing to a health check service, subscribing to performance indicators updates and subscribing to traffic prediction updates, for the plurality of delivery nodes.

15. The method of claim 14, further comprising:
receiving and storing performance indicators; and
updating a black list of delivery nodes as a function of the performance indicators.

16. The method of claim 14, further comprising:
receiving services statuses from the health check service; and
updating a black list of delivery nodes as a function of the services statuses.

17. The method of claim 14, further comprising, after receiving the traffic prediction from a traffic analyzer:
updating a black list of delivery nodes as a function of the traffic prediction.

18. The method of claim 13, wherein the network node is a request router and the second network node is a traffic analyzer.

19. The method of claim 15 wherein the performance indicators are received approximately every ten second.

20. The method of claim 16, wherein the services statuses are received approximately every second.

21. The method of claim 17, wherein traffic predictions are received continuously.

22. The method of claim 13, wherein selecting the delivery node further comprises:
locating a delivery nodes cluster based on the client proximity;
discarding delivery nodes from the delivery nodes cluster if said delivery nodes are listed in a blacklist of delivery nodes;
applying a content based request routing algorithm to select the delivery node; and
redirecting the request from the client to the delivery node selected.

23. (canceled)

24. A request router for handling a request for a content in a content delivery network comprising processing circuitry and a memory, said memory containing instructions executable by said processing circuitry whereby said request router is operative to:
receive the request for a content from a client;
obtain a traffic prediction for the content, for at least one of a plurality of delivery node;
responsive to obtaining the traffic prediction for the content, select a delivery node of the plurality of delivery nodes for serving the content to the client; and
send metadata associated to the request to a second network node.

25. (canceled)
